(19) United States
(12) Patent Application Publication
(10) Pub. No.: US 2020/0193558 A1
(43) Pub. Date: Jun. 18, 2020

(54) IMAGE PROCESSING SYSTEM AND IMAGE PROCESSING METHOD THEREOF

(71) Applicant: Coretronic Corporation, Hsin-Chu (TW)

(72) Inventor: Pei-Ming Shan, Hsin-Chu (TW)

(73) Assignee: Coretronic Corporation, Hsin-Chu (TW)

(21) Appl. No.: 16/709,935

(22) Filed: Dec. 11, 2019

(30) Foreign Application Priority Data
Dec. 14, 2018 (CN) 201811530918.1

(51) Int. Cl. G06T 1/60

(52) U.S. Cl. CPC G06T 1/60

(57) ABSTRACT

An image processing system and an image processing method thereof are provided. Compare the preset writing rate for the first processor to write image data into the memory with a reading rate for the second processor to read the image data written by the first processor from the memory. The image data includes a plurality of image frames. Determine a position for the second processor to perform a next reading operation of the image data from the memory according to a comparison result between the preset writing rate and the reading rate to perform a reading of the image data and to generate the image data of a next image frame when the second processor completes an outputting operation of one image frame and begins to perform a reading of a next image frame.

### CROSS-REFERENCE TO RELATED APPLICATION

This application claims the priority benefit of China application serial no. 201811530918.1, filed on Dec. 14, 2018. The entirety of the above-mentioned patent application is hereby incorporated by reference herein and made a part of this specification.

### BACKGROUND

### Technical Field

The invention relates to a processing apparatus, and more particularly, to an image processing system and an image processing method.

### Description of Related Art

In a general video processing, a frame buffer is usually required to execute functions such as deinterlacing, noise reduction and frame rate conversion. An input processor writes an input image to a frame buffer after performing appropriate image processing; an output processor then reads the image data from the frame buffer. After appropriate image processing, the image data is transmitted to a display device for display. If a crossover between a write pointer and a read pointer occurs during the reading and writing of the image data, “tearing” on the image picture presented by the display device may occur, which degrading display quality thereof.

Generally speaking, there are two approaches to avoid tearing on the image picture. One is Frame Synchronization; the other is Double Buffering. In frame synchronization, the relation between a frame rate of the image data of the output buffer and a frame rate of the image data of the input buffer maintains invariable in order to assure the image data that has just been written is to be read. However, if the output image is multi-picture (for example, picture-in-picture), Frame Synchronization can only synchronize the frame rate of the image data of the output buffer with a frame rate of a single input image data—instead of synchronizing with two different frame rates at once. In Double Buffering, two buffers are applied to write image data into one buffer and read image data from the other buffer. Nevertheless, if switching to one buffer is performed before the image data stored in the other buffer has been completely read out, tearing occurs. In the case of that the frame rate of the input image data is higher than the frame rate of the output image data, when one buffer is quickly written and another buffer is switched to be written, the image data output by the other buffer without being completely read out would be overwritten by the image data to be written in. This again causes tearing, and display quality of the display device is deteriorated.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to an image processing system and an image processing method, which prevent a crossover between a read pointer and a write pointer, avoid image tearing, and improve display quality of a display device.

Other objectives and advantages of the invention would be further detailed by the disclosures herein.

To achieve at least one of the above-mentioned objectives or other objectives, an embodiment of the invention provides an image processing system, including a memory, a first processor, a second processor and a comparator. The first processor is coupled to the memory and receives image data, and the first processor writes the image data into the memory at a preset writing rate. The image data includes a plurality of image frames. The second processor is coupled to the memory and reads the image data written by the first processor from the memory. The comparator is coupled to the first processor and the second processor. The comparator compares the preset writing rate of the first processor with a reading rate of the second processor. The second processor determines a position to perform a next reading of the image data from the memory according to a comparison result of the comparator, so as to perform a reading of the image data and to generate image data of a next image frame when the second processor completes an outputting operation of one image frame and begins to read a next image frame.

The invention further provides an image processing method of an image processing system. The image processing system includes a memory, a first processor and a second processor. The image processing method includes the following steps. Compare the preset writing rate for the first processor to write image data into the memory with a reading rate for the second processor to read the image data written by the first processor from the memory. The image data includes a plurality of image frames. Determine a position for the second processor to perform a next reading of the image data from the memory according to a comparison result between the preset writing rate and the reading rate so as to perform a reading of the image data and to generate image data of a next image frame when the second processor completes an outputting operation of one image frame and begins to read a reading of a next image frame.

In view of the foregoing, the embodiments of the invention determine the position of the next reading of image data from the memory for the second processor according to the comparison result between the preset writing rate of the first processor and the reading rate of the second processor. Accordingly, a crossover between the write pointer and the read pointer rarely occurs, image tearing can be prevented, and the display quality of the display device can be improved.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating an image processing system according to an embodiment of the invention.

FIG. 2 is a schematic diagram illustrating the reading and writing of image data for a memory according to an embodiment of the invention.

FIG. 3 is a schematic diagram illustrating the reading and writing of image data for a memory according to another embodiment of the invention.

FIG. 4 is a flowchart illustrating an image processing method of an image processing system according to an embodiment of the invention.

FIG. 5 is a flowchart illustrating an image processing method of an image processing system according to another embodiment of the invention.

FIG. 6 is a flowchart illustrating an image processing method of an image processing system according to another embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical contents, features, and advantages of the present invention are described in the following detailed description of a preferred embodiment with reference to the accompanying drawings will be clearly presented. The directional terms mentioned in the following embodiments, for example, up, down, left, right, front or back, etc., are only directions with reference to the drawings. Therefore, the directional terminology used is for the purpose of illustration and not limitation.

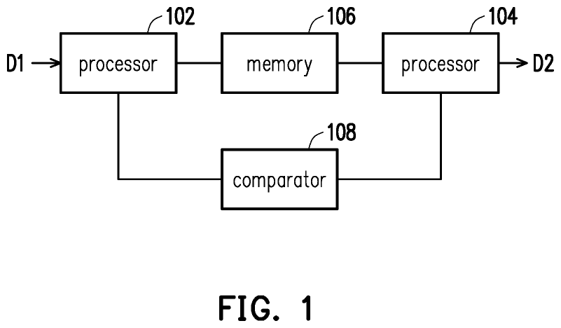

FIG. 1 is a schematic diagram illustrating an image processing system according to an embodiment of the invention. Please refer to FIG. 1. An image processing system includes processors 102 and 104, a memory 106 and a comparator 108. The memory 106 is coupled to the processors 102 and 104; the comparator 108 is coupled to the processors 102 and 104. The memory 106 may be implemented by, for example, but not limited thereto, a dynamic random access memory (DRAM). The processor 102 is able to receive image data D1, which includes a plurality of image frames, and write the image data D1 into the memory 106 at a preset writing rate, which may be for example constant or time-invariant. The processor 104 is able to read image data written by the processor 102 from the memory 106 at a reading rate, and output image data D2 to a display device (not shown) at the back end for image displaying. The comparator 108 is able to compare the preset writing rate of the processor 102 with the reading rate of the processor 104, and send a comparison result to the processor 104. Every time the processor 104 finishes reading operation and outputs one image frame and starts to read the next image frame, the processor 104 determines a position to perform a next reading of image data from the memory 106 according to the comparison result of the comparator 108 so as to perform image data reading and generate the image data D2 of a next image frame. Because the timing that the processor 104 finishes the reading and outputting of one image frame serves as a checkpoint, and the position to perform a next reading of image data is determined according to the preset writing rate of the processor 102 and the reading rate of processor 104, it prevents tearing on image pictures due to a crossover between a write pointer and a read pointer. In this embodiment, the comparator 108 keeps comparing the preset writing rate of the processor 102 to the reading rate of the processor 104. Every time the processor 104 finishes reading operation and outputting one image frame and starts to read a next image frame, the processor 104 is able to receive the comparison result from the comparator 108 immediately and determine the position at which image data in the memory 106 is read next. However, the present invention is not limited thereto.

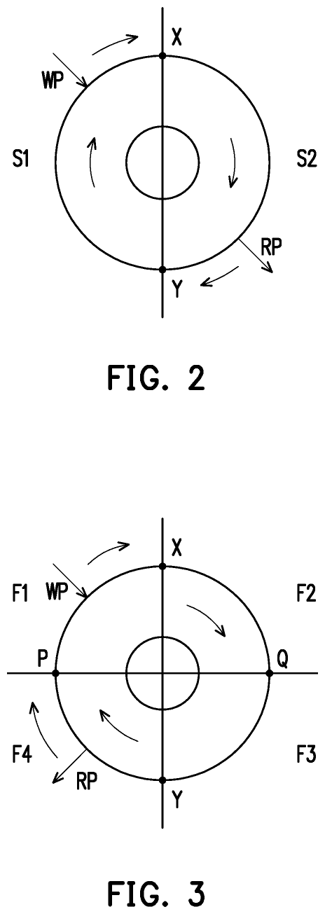

For example, FIG. 2 is a schematic diagram illustrating the reading and writing of image data for a memory according to an embodiment of the invention. Please refer to FIG. 2. In this embodiment, the image data D1 is progressive scan image data. The memory 106 may include a buffer S1, which is represented by a left semicircle shown in FIG. 2, and a buffer S2, which is represented by a right semicircle shown in FIG. 2. The preset writing rate of the processor 102 is represented by a speed of the write pointer WP moving in a clockwise direction; the reading rate of the processor 104 is represented by a speed of the read pointer RP moving in the clockwise direction. The processor 102 in this embodiment is able to write the image data D1 into the buffer S1 and the buffer S2 in turn at the preset writing rate. In other words, the write pointer WP moves in the clockwise direction around a circle at a constant speed, and the checkpoint X and the checkpoint Y on the circumference may represent the timings that the processor 102 or 104 complete the reading or writing of one image frame. When the processor 104 finishes the reading and outputting of one image frame and begins to read a next image frame, the processor 104 determines to read the next image frame out of the buffer S1 or the buffer S2 of the memory 106 according to the comparison result from the comparator 108.

For example, when the read pointer RP moves to the checkpoint Y (that is to say, after the reading of the image frame stored in the buffer S2 is completed), if the comparison result of the comparator 108 indicates that the preset writing rate of the processor 102 is greater than or equal to the reading rate of the processor 104 and that the processor 102 is currently writing the buffer S1, the processor 104 reads a next image frame from the buffer S1 according to the comparison result, meaning that the read pointer RP continues moving in the clockwise direction from the checkpoint Y. Because the speed of the write pointer WP is greater than or equal to the speed of the read pointer RP, before the processor 102 completes the writing operation of one image frame to the buffer S1—that is, before the write pointer WP reaches the checkpoint X—the read pointer RP does not overtake the write pointer WP, which prevents crossovers.

On the other hand, if the comparison result of the comparator 108 indicates that the preset writing rate of the processor 102 is lower than the reading rate of the processor 104 and that the processor 102 is currently writing the buffer S1, the processor 104, based on the comparison result, may select the buffer S2 to read a next image frame, namely that the read pointer RP continues to move in the clockwise direction from the checkpoint X. Since the speed of the write pointer WP is lower than the speed of the read pointer RP, before the processor 104 completes the reading of one image frame from the buffer S1—that is, before the read pointer RP reaches the checkpoint Y—the write pointer WP does not overtake the read pointer RP to avert a crossover. Even if the read pointer RP moves fast, the read pointer RP never catches up with the write pointer WP because the position to read a next image frame is redetermined when the read pointer RP reaches the checkpoint Y. Following this logic, whenever the read pointer RP arrives at the checkpoint (meaning that the processor 104 completes the reading of one image frame), the processor 104 selects a buffer to start reading a next image frame according to the comparison result of the comparator 108, thereby preventing a crossover between the read pointer RP and the write pointer WP, avoiding image frame tearing, and improving display quality of the display device.

For example, FIG. 3 is a schematic diagram illustrating the reading and writing of image data for a memory according to another embodiment of the invention. Please refer to FIG. 3. In this embodiment, the image data D1 is interlaced scan image data. The memory 106 includes a buffer for storing a plurality of field data. One image frame may include a plurality of field data. As shown in FIG. 3, the memory 106 may store two odd field data F1, F3 and two even field data F2, F4. In this embodiment, one image frame may include two fields (that is, an odd field data and an even field data). When deinterlacing—such as Motion Adaptive Deinterlace (MADI), but not limited thereto—is utilized to generate the image data D2 for rendering image pictures, the processor 104 needs three consecutive field data simultaneously (for example, “odd field data F1, even field data F2 and odd field data F3,” or “even field data F4, odd field data F1 and even field data F2,” but not limited thereto) to perform processes such as spatial interpolation or image merging in order to generate the image data D2 to be transmitted to the back end display device.

Similarly, the processor 102 of the embodiment also cyclically writes the odd field data F1, the even field data F2, the odd field data F3, and the even field data F4 into the memory 106 in chronological order at the preset writing rate. In other words, the write pointer WP moves circumferentially at a fixed speed in a clockwise direction. The checkpoints X, Q, Y, P on the circumference may stand for the timings that the processor 102 or 104 completes the writing or reading operation of one field data. whenever the processor 104 finishes the reading and outputting one image frame and begins to read a next image frame, the processor 104 determines the position to start the reading of a next field data according to the comparison result of the comparator 108.

Specifically, when the processor 102 writes the nth field data to the memory 106 (namely the buffer) and the processor 104 completes the outputting of one image frame and starts to read a next image frame, if the comparison result of the comparator 108 indicates that the preset writing rate of the processor 102 is greater than or equal to the reading rate of the processor 104, the processor 104 simultaneously reads and deinterlaces the nth, (n−1)th, and (n−2)th field data from the memory 106 according to the comparison result so as to generate the image data D2 of the next image frame. If the comparison result of the comparator 108 shows that the preset writing rate of the processor 102 is lower than the reading rate of the processor 104, the processor 104 simultaneously reads and deinterlaces the (n−1)th, (n−2)th and (n−3)th field data from the memory 106 based on the comparison result to generate the image data D2 of the next image frame.

For example, when the processor 102 writes the odd field data F1 to the memory 106 and the processor 104 completes the outputting of one image frame (for example, the read pointer RP moves to the checkpoint P) and begins to read a next image frame, if the comparison result of the comparator 108 indicates that the preset writing rate of the processor 102 is greater than or equal to the reading rate of the processor 104, the processor 104 starts reading the odd field data F1, the even field data F4, and the odd field data F3 of the memory 106 simultaneously from the checkpoint P according to the comparison result. Since the speed of the write pointer WP is greater than or equal to the speed of the read pointer RP, the read pointer RP does not overtake the write pointer WP before the processor 102 finishes writing the odd field data F3 (that is to say, before the write pointer WP reaches the checkpoint Y), thus preventing crossovers.

On the other hand, if the preset writing rate of the processor 102 is lower than the reading rate of the processor 104 and the processor 102 is currently writing the odd field data F1 to the memory 106, the processor 104 may determine to start reading the even field data F4, the odd field data F3, and the even field data F2 of the memory 106 from the checkpoint Y. Since the processor 104 selects the previous checkpoint to begin the reading operation of field data, a distance between the write pointer WP and the read pointer RP increases. Therefore, before the processor 104 completes the reading of one image frame (in other words, before the read pointer RP reaches the checkpoint Q), the write pointer WP is not overtaken by the read pointer RP and a crossover rarely occurs. Following this logic, whenever the processor 104 completes the reading of one image frame, the processor 104 selects a checkpoint to start reading a next image frame according to the comparison result of the comparator 108, thereby preventing a crossover between the read pointer RP and the write pointer WP, avoiding image frame tearing, and improving display quality of the display device.

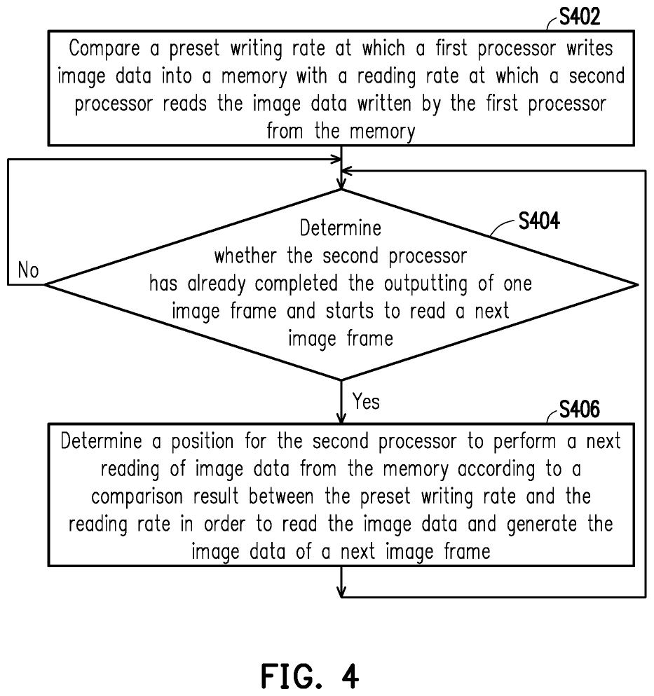

FIG. 4 is a flowchart illustrating an image processing method of an image processing system according to an embodiment of the invention. It can be seen from the above embodiments that the image processing method of the image processing system may include at least the following steps. First, compare a preset writing rate at which a first processor writes image data into a memory with a reading rate at which a second processor reads the image data written by the first processor from the memory (step S402). The image data includes a plurality of image frames. Next, determine whether the second processor completes the outputting of one image frame and starts to read a next image frame (step S404). If the second processor has not finished outputting one image frame yet, return to step S404. If the second processor has completed the outputting of one image frame, a position to perform a next reading of image data from the memory via the second processor according to a comparison result between the preset writing rate and the reading rate is determined in order to read the image data and generate the image data of a next image frame (S406). When step S406 is completed, proceed to step 404 to determine whether the second processor completes the outputting of one image frame and starts to read a next image frame. In step S402, the preset writing rate of the first processor and the reading rate of the second processor are ceaselessly compared.

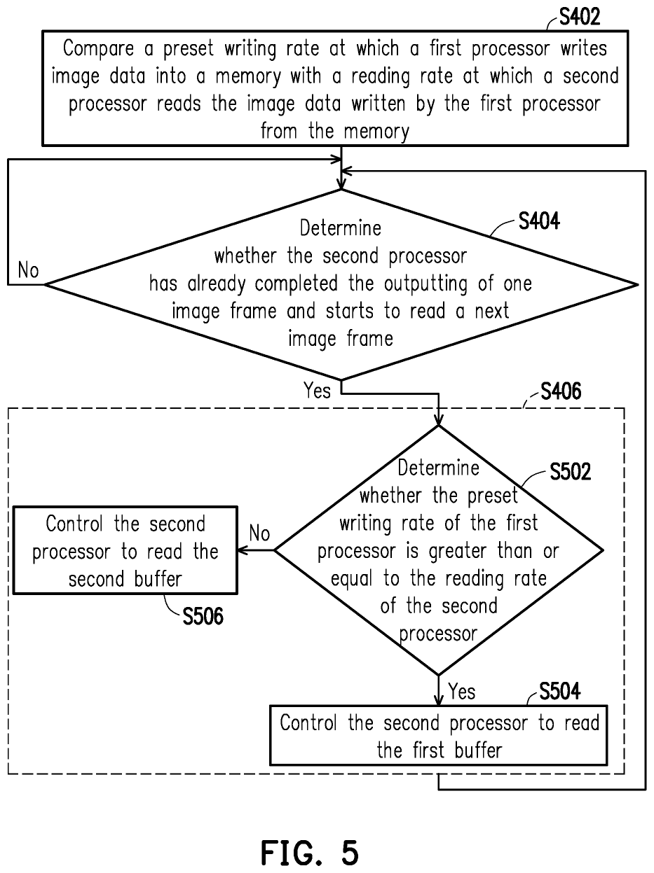

FIG. 5 is a flowchart illustrating an image processing method of an image processing system according to another embodiment of the invention. In this embodiment, the image processing system includes a memory, a first processor and a second processor. Image data received by the first processor is progressive scan image data. The memory includes a first buffer and a second buffer. The first processor writes image data into the first buffer and the second buffer in turn at a preset writing rate. In other words, after finishing writing one image frame into one of the first buffer and the second buffer, the first processor turns to the writing of a next image frame into the other buffer. Step S406 of this embodiment may include steps S502 to S504. Step S502 includes determining whether the preset writing rate of the first processor is greater than or equal to the reading rate of the second processor. If the preset writing rate of the first processor is greater than or equal to the reading rate of the second processor, control the second processor to read the first buffer (step S504). If the preset writing rate of the first processor is lower than the reading rate of the second processor, the second processor is controlled to read the second buffer (step S506).

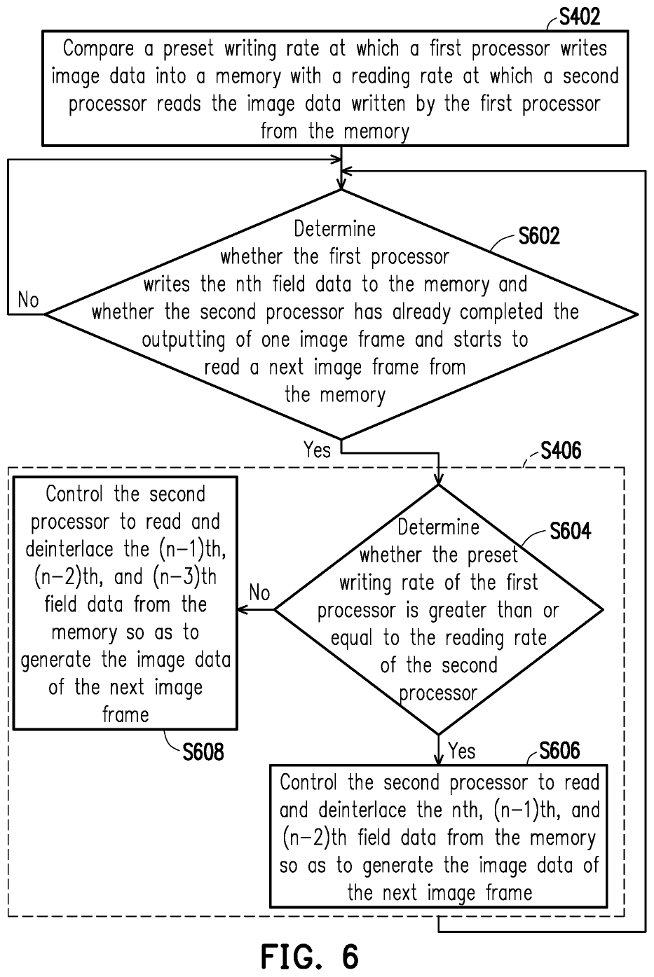

FIG. 6 is a flowchart illustrating an image processing method of an image processing system according to another embodiment of the invention. In this embodiment, image data received by a first processor is interlaced scan image data. One image frame may include a plurality of field data (e.g., a plurality of odd field data and a plurality of even field data). In this embodiment, one image frame includes an odd field data and an even field data, but not limited thereto. A memory of the image processing system includes a buffer, which is able to store the plurality of field data written by the first processor in chronological order—for example, two odd field data and two even field data may be simultaneously stored, but not limited thereto. The first processor alternately writes the odd field data and the even field data to the memory (i.e., the buffer) at a preset writing rate. The image processing method of the image processing system in this embodiment may include at least the following steps. First, compare the preset writing rate at which a first processor writes image data into a memory with a reading rate at which a second processor reads the image data written by the first processor from the memory (step S402). The image data includes a plurality of image frames. Next, determine whether the first processor writes the nth field data to the memory and whether the second processor completes the outputting of one image frame and starts to read a next image frame from the memory (step S602). If the second processor has not finished outputting one image frame yet but intend to read a next image frame, return to step S602. If the first processor writes the nth field data to the memory and the second processor starting to read a next image frame from the memory has completed the outputting of the image frame, determine whether the preset writing rate of the first processor is greater than or equal to the reading rate of the second processor (step S604). If the preset writing rate of the first processor is greater than or equal to the reading rate of the second processor, control the second processor to simultaneously read and deinterlace the nth, (n−1)th, and (n−2)th field data from the memory so as to generate the image data of the next image frame (step S606). If the preset writing rate of the first processor is lower than the reading rate of the second processor, the second processor is controlled to simultaneously read and deinterlace the (n−1)th, (n−2)th and (n−3)th field data from the memory to generate the image data of the next image frame (step S608). When step S606 or S608 is completed, proceed to step 602 to determine whether the first processor writes the nth field data to the memory and whether the second processor completes the outputting of one image frame and starts to read a next image frame.

To sum up, the embodiments of the invention determine the position of the next reading of image data from the memory for the second processor according to the comparison result between the preset writing rate of the first processor and the reading rate of the second processor. Accordingly, a crossover between the write pointer and the read pointer rarely occurs, image tearing can be prevented, and the display quality of the display device can be improved. In addition, as can be seen from the above embodiments, the image processing system and the image processing method of the invention is always feasible whether the input image data is progressive scan image data or interlaced scan image data. Without additionally increasing capacity and bandwidth of a memory, even uncomplicated circuits can avoid tearing on image pictures in the present invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An image processing system, comprising: a memory, a first processor, a second processor and a comparator, wherein
the first processor is coupled to the memory and receives image data, the first processer writes the image data into the memory at a preset writing rate, the image data comprises a plurality of image frames;
the second processor is coupled to the memory and reads the image data written by the first processor from the memory;
the comparator is coupled to the first processor and the second processor, and compares the preset writing rate of the first processor with a reading rate of the second processor; and
the second processor determines a position to perform a next reading of the image data from the memory according to a comparison result of the comparator so as to perform a reading of the image data and to generate image data of a next image frame, when the second processor completes an outputting operation of one image frame and begins to read a next image frame.

2. The image processing system according to claim 1, wherein the memory comprises a first buffer and a second buffer, wherein
the first processor writes the image data into the first buffer and the second buffer in turn at the preset writing rate,
the second processor reads the first buffer if the preset writing rate is greater than or equal to the reading rate when the first processor writes the image data into the first buffer and the second processor completes the outputting operation of the one image frame and begins to read the next image frame, and
the second processor reads the second buffer if the preset writing rate is lower than the reading rate when the first processor writes the image data into the first buffer and the second processor completes the outputting operation of the one image frame and begins to read the next image frame.

3. The image processing system according to claim 2, wherein after the first processor finishes writing the one image frame into one of the first buffer and the second buffer, the first processor turns to a writing operation of the next image frame into the other of the first buffer and the second buffer.

4. The image processing system according to claim 2, wherein the image data is progressive scan image data.

5. The image processing system according to claim 1, wherein the plurality of image frames comprise a plurality of field data, the memory comprises:
a buffer storing the plurality of field data written by the first processor in a chronological order;
the second processor reads and deinterlaces nth, (n−1)th, and (n−2)th field data to generate the image data of the next image frame if the preset writing rate is greater than or equal to the reading rate when the first processor writes the nth field data into the buffer and the second processor completes the outputting operation of the one image frame and begins to read the next image frame;
the second processor reads and deinterlaces (n−1)th, the (n−2)th and (n−3)th field data to generate the image data of the next image frame if the preset writing rate is lower than the reading rate when the first processor writes the nth field data into the buffer and the second processor completes the outputting operation of the one image frame and begins to read the next image frame.

6. The image processing system according to claim 5, wherein the image data is interlaced scan image data, the plurality of field data comprise a plurality of odd field data and a plurality of even field data, and the first processor alternately writes the plurality of odd field data and the plurality of even field data into the buffer at the preset writing rate.

7. The image processing system according to claim 6, wherein the buffer stores at least two of the plurality of odd field data and at least two of the plurality of even field data.

8. An image processing method of an image processing system, wherein the image processing system comprises a memory, a first processor and a second processor, and the image processing method comprises:
comparing a preset writing rate for the first processor to write image data into the memory with a reading rate for the second processor to read the image data written by the first processor from the memory, the image data comprises a plurality of image frames; and
determining a position for the second processor to perform a next reading of the image data from the memory according to a comparison result between the preset writing rate and the reading rate so as to perform a reading of the image data and to generate image data of a next image frame when the second processor completes an outputting operation of one image frame and begins to read a next image frame.

9. The image processing method according to claim 8, wherein the memory comprises a first buffer and a second buffer,
the first processor writes the image data into the first buffer and the second buffer in turn at the preset writing rate,
the image processing method comprises:
determining whether the preset writing rate is greater than or equal to the reading rate when the first processor writes the first memory and the second processor completes the outputting operation of the one image frame and begins to read the next image frame;
controlling the second processor to read the first buffer if the preset writing rate is greater than or equal to the reading rate; and
controlling the second processor to read the second buffer if the preset writing rate is lower than the reading rate.

10. The image processing method according to claim 9, wherein after the first processor finishes writing the one image frame into one of the first buffer and the second buffer, the first processor turns to a writing operation of the next image frame into the other of the first buffer and the second buffer.

11. The image processing method according to claim 9, wherein the image data is progressive scan image data.

12. The image processing method according to claim 8, wherein the plurality of image frames comprise a plurality of field data,
the memory comprises a buffer, the buffer stores the plurality of field data written by the first processor in a chronological order, and
the image processing method comprises:
determining whether the preset writing rate is greater than or equal to the reading rate when the first processor writes nth field data into the buffer and the second processor completes the outputting operation of the one image frame and begins to read the next image frame;
controlling the second processor to read and deinterlace the nth, (n−1)th, and (n−2)th field data to generate the image data of the next image frame if the preset writing rate is greater than or equal to the reading rate; and
controlling the second processor to read and deinterlace the (n−1)th, the (n−2)th and (n−3)th field data to generate the image data of the next image frame if the preset writing rate is lower than the reading rate.

13. The image processing method according to claim 12, wherein the image data is interlaced scan image data, the plurality of image frames comprise a plurality of odd field data and a plurality of even field data, and the first processor alternately writes the plurality of odd field data and the plurality of even field data into the buffer at the preset writing rate.

14. The image processing method according to claim 12, wherein the buffer stores at least two of the plurality of odd field data and at least two of the plurality of even field data.
